(19) United States
(12) Patent Application Publication
(10) Pub. No.: US 2005/0151791 A1
(43) Pub. Date: Jul. 14, 2005

(54) Monolithic fluid injection device and method of fabricating the same

(76) Inventor: Chung-Cheng Chou, Lujhu Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/030,852

(22) Filed: Jan. 7, 2005

(30) Foreign Application Priority Data
Jan. 13, 2004 (TW) 93100755

(51) Int. Cl. B41J 2/21

(52) U.S. Cl. 347/43

(57) ABSTRACT

A monolithic fluid injection device. A substrate, a structural layer formed thereon, a manifold installed in the substrate to supply fluid, a plurality of first chambers and at least one second chamber installed between the substrate and the structural layer to contain fluid, a channel between the substrate and the structural layer to supply fluid to the second chamber, and a plurality of nozzles through the structural layer, connected with the first and second chambers, to inject fluid, are formed such that the manifold connects directly to the first chambers, and indirectly to the second chamber. A method of fabricating the above monolithic fluid injection device is also disclosed.

### BACKGROUND OF THE INVENTION

1. Field of the Invention

The present invention relates to a semiconductor device, and more specifically to a monolithic fluid injection device and method of fabricating the same.

2. Description of the Related Art

Currently, fluid injection is widely used in various technological products, such as ink jet printheads, fuel oil injection devices, or pharmaceutical injection mechanism.

A related fluid injection device, having a plurality of manifolds, is disclosed in U.S. Pat. No. 6,267,468, and illustrated in FIG. 1a to 1c, wherein FIG. 1a is a top view of the device, FIG. 1b is a bottom view of the device, and FIG. 1c is a perspective drawing of the device.

The disclosed fluid injection device comprises a silicon substrate 11 having three manifolds 71˜73 and a plurality of channels 29 to transport fluid, the chambers 19 installed on both sides of the manifolds 71˜73 to contain fluid, and a plurality of nozzles 21 installed on the surface of the chambers 19 to inject fluid.

With regard to the above device structure, one manifold corresponds to two rows of chambers 19, such that the number of manifolds is increased with the number of chambers to improve density, thereby increasing complexity and process cost.

A conventional fabrication process for a fluid injection device is disclosed as the following steps, and illustrated in FIGS. 2a to 2b. Referring to FIG. 2a, a substrate 10 is provided, such as a silicon substrate, and a patterned sacrificial layer 20 is formed thereon. The sacrificial layer 20 comprises silicon oxide. Subsequently, a patterned structural layer 30 is formed on the substrate 10 to cover the patterned sacrificial layer 20. The structural layer 30 may comprise silicon nitride formed by chemical vapor deposition (CVD).

Next, a patterned resist layer 40 is formed on the structural layer 30 as an actuator, such as a heater. The resist layer 40 comprises HfB₂, TaAl, TaN, or TiN. A patterned isolation layer 50 is then formed to cover the structural layer 30 and the resist layer 40, and heater contact 45 is formed. Next, a patterned conductive layer 60 is formed on the structural layer 30, and fills the heater contact 45 to form a signal transmission line 62. Finally, a protective layer 70 is formed on the substrate 10 to cover the isolation layer 50 and the conductive layer 60, forming a signal transmission line contact 75 in the protective layer 70, and exposing the conductive layer 60 to facilitate subsequent packaging process.

Subsequently, referring to FIG. 2b, the back of the substrate 10 is firstly wet etched using KOH to form a manifold 80 and an opening 100, exposing the sacrificial layer 20. The sacrificial layer 20 is then removed by HF. The substrate 10 is etched by KOH repeatedly, and a chamber 90 is thus formed. Finally, the protective layer 70, the isolation layer 50, and the structural layer 30 are etched in order, to form a nozzle 95 connected to the chamber 90.

According to the described fabrication process, more than one instance of etching is required to fabricate sufficient numbers of corresponding manifolds, as the number of chambers is increased. Further, after etching, a back opening is larger than a front opening of the manifold 80, thereby substantially occupying valuable wafer area.

### SUMMARY OF THE INVENTION

In order to solve the conventional problems, an object of the invention is to provide a single-manifold fluid injection device to obtain high injection density.

To achieve the above objects, the invention provides a monolithic fluid injection device including a substrate with a structural layer formed thereon, a manifold installed in the substrate to supply fluid, a plurality of first chambers and at least one second chamber, installed between the substrate and the structural layer to contain fluid, a channel between the substrate and the structural layer to supply fluid to the second chamber, and a plurality of nozzles through the structural layer, connected with the first and second chambers, to inject fluid, wherein the manifold connects directly to the first chambers, and indirectly to the second chamber.

Based on the above structure, the present invention provides more amounts of chambers to improve injection density without increasing the number of manifolds. Additionally, chambers are staggered, thereby improving injection rate per unit time.

Another object of the invention is to provide a method of fabricating the monolithic fluid injection device, including the following steps. A substrate is provided, and a patterned sacrificial layer is formed thereon, as a predetermined region where a channel and a plurality of chambers are subsequently formed. Next, a patterned structural layer is formed on the substrate to cover the patterned sacrificial layer. A manifold through the substrate is then formed, exposing the patterned sacrificial layer. Subsequently, the sacrificial layer is removed to form the channel and the chambers. Next, the structural layer is etched to form a plurality of nozzles connected to chambers, wherein the chambers comprise a plurality of first chambers and at least one second chamber, the first chambers directly connect to the manifold, and the second chamber connects to the manifold by the channel.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIGS. 1a˜1c are cross sections of fabrication of a fluid injection device as disclosed in U.S. Pat. No. 6,267,468.

FIGS. 2a˜2b are cross sections of fabrication of a conventional fluid injection device.

FIGS. 3a, 3b, and 4 are cross sections of the method of fabricating a monolithic fluid injection device in the first embodiment of the invention.

FIGS. 5a, 5b, and 6 are cross sections of the method of fabricating a monolithic fluid injection device in the second embodiment of the invention.

FIGS. 7a, 7b, and 8 are cross sections of the method of fabricating a monolithic fluid injection device in the third embodiment of the invention.

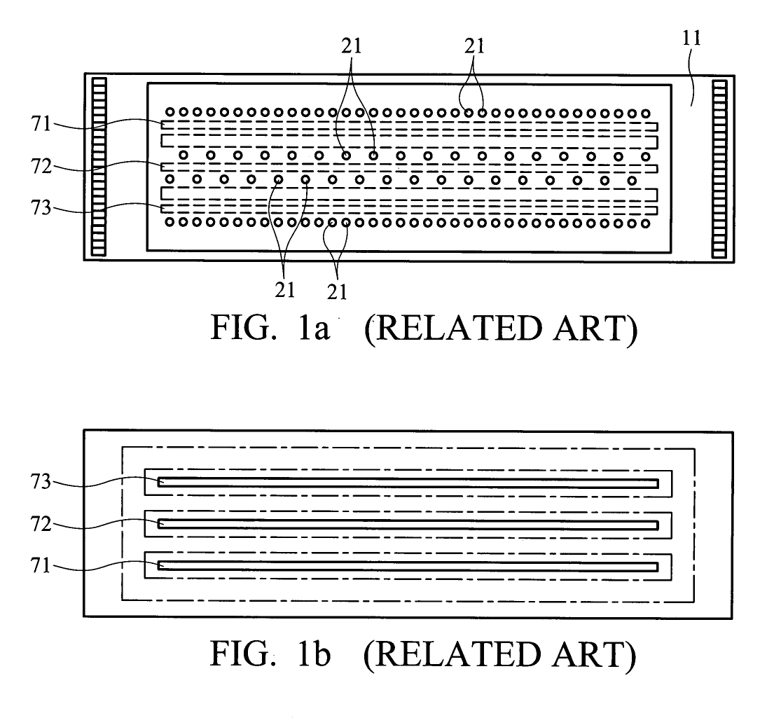

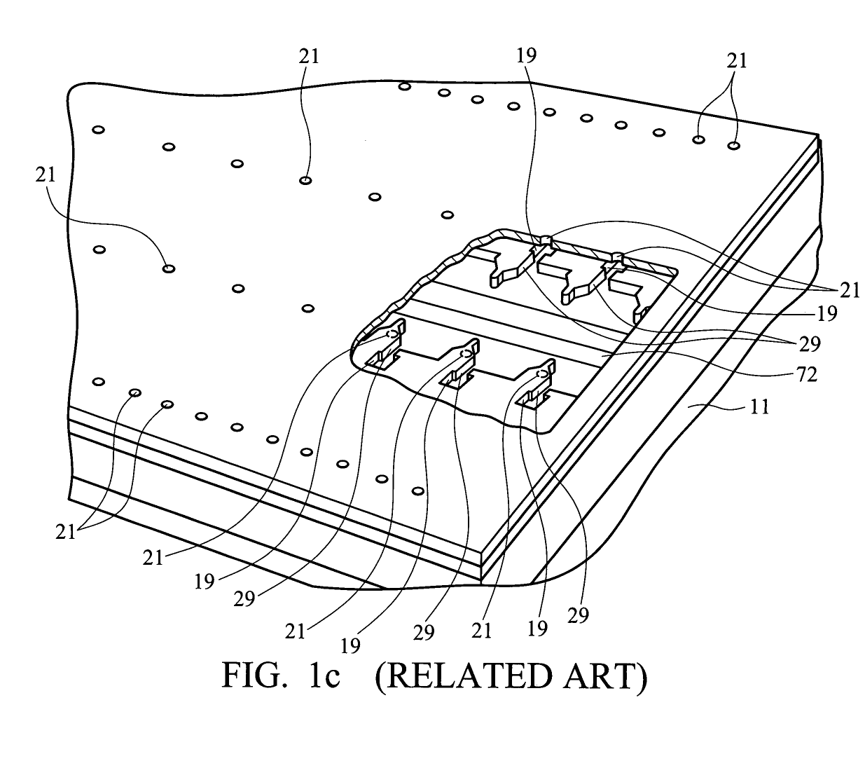

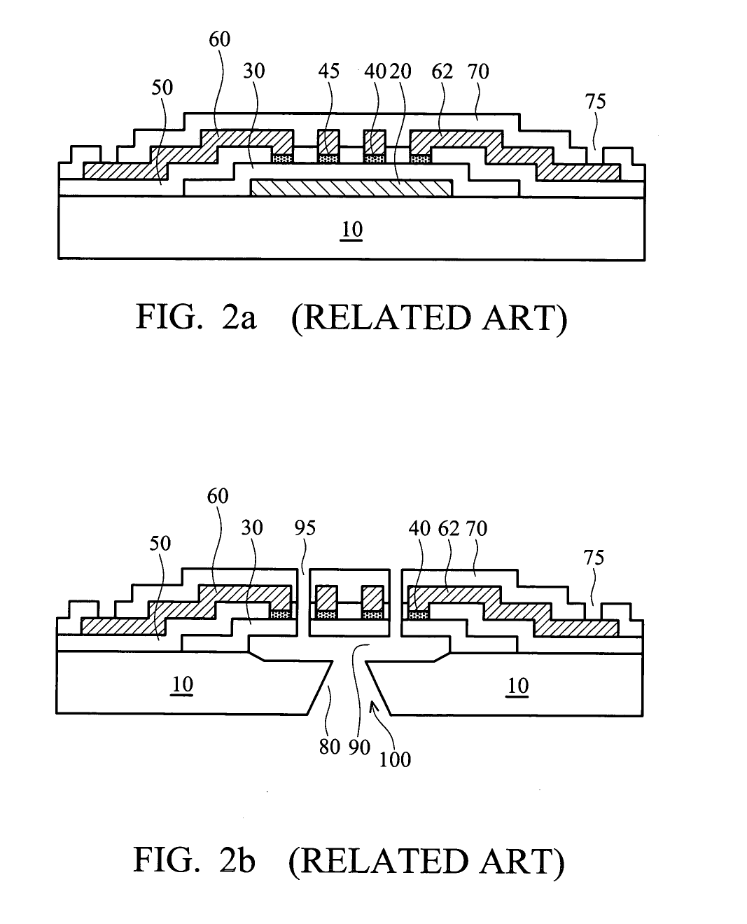

### DETAILED DESCRIPTION OF THE INVENTION

### First Embodiment

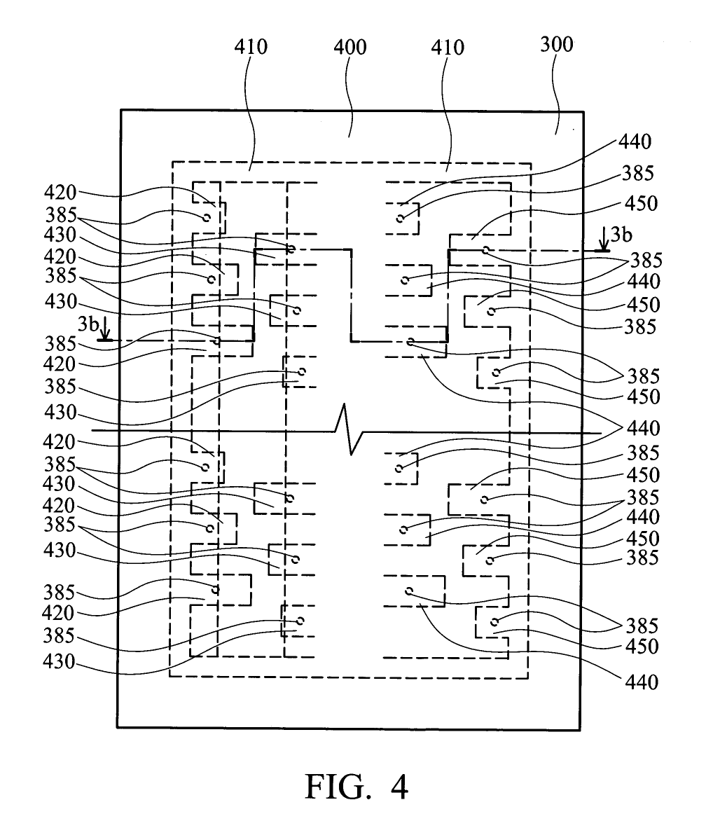

The fluid injection device in this embodiment features a connection system for chambers 420, 430, 440, 450, the channel 410, and the manifold 400, positioned as shown in FIG. 4.

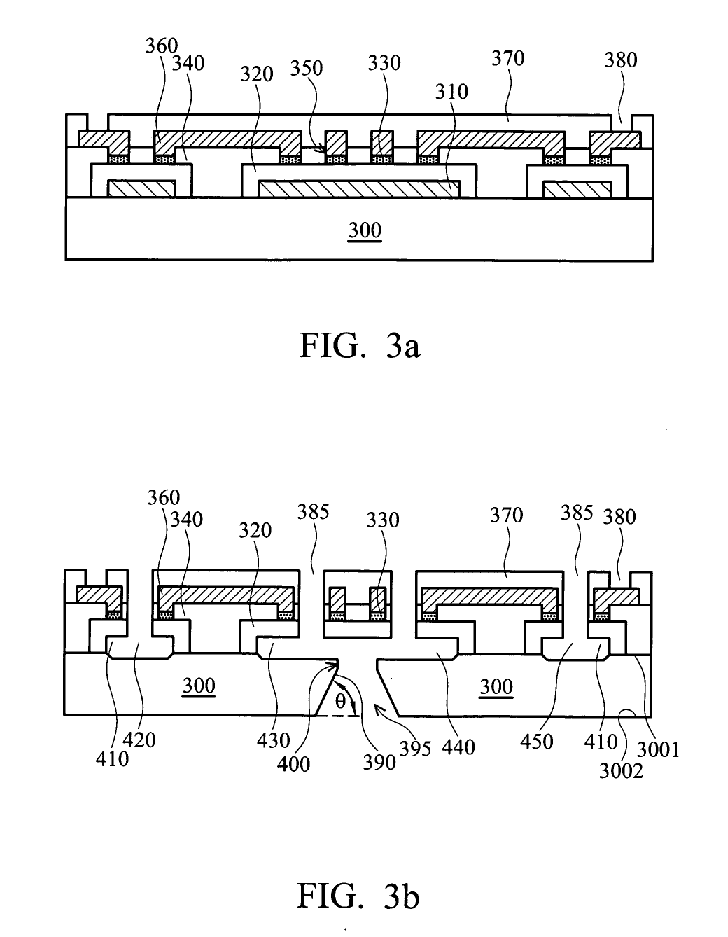

The above structure is illustrated in FIG. 3b (a cross section) and FIG. 4 (a top view), wherein FIG. 3b is a cross section along the tangent line 3b-3b of FIG. 4. The full structure includes a substrate 300, a fluid channel 390, a manifold 400, four rows of chambers 420, 430, 440, 450, a channel 410, a structural layer 320, a resist layer 330, an isolation layer 340, a conductive layer 360, a protective layer 370, a plurality of signal transmission line contacts 380, and a plurality of nozzles 385.

The fluid channel 390 and the manifold 400 are formed in the substrate 300, wherein the manifold 400 is a narrow section of the fluid channel 390. Four rows of chambers 420, 430, 440, 450 and channel 410 are formed between the substrate 300 and the structural layer 320, wherein chambers 430 and 440 are connected with the manifold 400, and chambers 420 and 450 are connected with the channel 410. The manifold 400 connects to the channel 410, owing to the circular channel 410 around the chambers 420, 430, 440, 450. Thus, the connection of the chambers 420, 430, 440, 450, the channel 410, and the manifold 400 is formed, and chambers 430 and 440 are staggered, wherein the chambers 420 and 440, 430 and 450 are paired symmetrically.

Structural layer 320 covers the substrate 300 and chambers 420, 430, 440, 450. The resist layer 330 is installed on the structural layer 320, and both sides of nozzles. The resist layer 330 represents a plurality of fluid actuators, such as heaters, driving fluid out of nozzles 385. The isolation layer 340 covers the substrate 300, the structural layer 320, and the resist layer 330, exposing a portion of the resist layer 330 to form heater contacts. The conductive layer 360 covers the isolation layer 340 and fills heater contacts to form signal transmission lines.

The protective layer 370 covers the isolation layer 340 and the conductive layer 360, exposing a portion of the conductive layer 360 to form a plurality of signal transmission line contacts 380, thereby facilitating the subsequent packaging process. A plurality of nozzles 385 are formed through the protective layer 370, the isolation layer 340, and the structural layer 320, and connected to the chambers 420, 430, 440, 450.

The device structure of the embodiment features the connection of chambers 420, 430, 440, 450, the channel 410, and the manifold 400. Compared to the related art, in which one row of chambers corresponds to one manifold, the embodiment provides all chambers 420, 430, 440, 450 corresponding to the single manifold 400, thereby reducing complexity of process. In addition, staggering of the chambers 430 and 440 significantly improves injection density.

Referring to FIGS. 3a, 3b, and 4, a method of fabricating the monolithic fluid injection device is provided. First, referring to FIG. 3a, a substrate 300 is provided, such as a silicon substrate. The thickness of the substrate 300 is about 625˜675 μm. Subsequently, a patterned sacrificial layer 310 is formed on a first plane 3001 of the substrate 300. The sacrificial layer 310 comprises BPSG, PSG, or silicon oxide, preferably PSG. The thickness of the sacrificial layer 310 is about 1˜2 μm.

Referring to FIG. 4, the above patterned sacrificial layer is formed in a predetermined region of a channel 410 and four rows of chambers 420, 430, 440, 450.

Next, a patterned structural layer 320 is formed on the substrate 300 to cover the patterned sacrificial layer 310. The structural layer 320 may be silicon nitride formed by CVD. The thickness of the structural layer 320 is about 1.5˜2 μm. Additionally, the structural layer 320 is a low-stress material with stress thereof about 100˜200 MPa.

Subsequently, a patterned resist layer 330 is formed on the structural layer 320, as fluid actuators, such as heaters, thereby driving fluid out of subsequently formed nozzles. The resist layer 330 comprises HfB₂, TaAl, TaN, or TiN, and is preferably TaAl.

A patterned isolation layer 340 is then formed to cover the substrate 300, the structural layer 320 and the resist layer 330, forming heater contacts 350. Subsequently, a patterned conductive layer 360 is formed on the isolation layer 340, filling heater contacts 350 to form signal transmission lines. Finally, a protective layer 370 is formed on the isolation layer 340 and the conductive layer 360, exposing the conductive layer 360, thereby forming signal transmission line contacts 380 to facilitate the subsequent packaging process.

Subsequently, referring to FIG. 3b, a series of etching steps is performed. First, a second plane 3002 of the substrate 300 is etched to form a fluid channel 390, a manifold 400, and an opening 395 by anisotropic wet etching using TMAH or KOH, exposing the sacrificial layer 310.

The width of the manifold 400 is about 160˜200 μm, and the width of the opening 395 is about 1000˜1200 μm. The included angle between the side walls of the fluid channel 390 and the horizontal factor is about 54.74°. Therefore, after etching, a fluid channel 390 with a back opening larger than a front opening is formed. Additionally, the fabrication process is a monolithic process because the fluid channel 390 is fabricated in the substrate 300. Furthermore, the fluid channel 390 connects to a fluid storage tank.

Next, the sacrificial layer 310 is removed by HF, and the substrate 300 is subsequently etched by a basic etching solution, such as KOH, to enlarge the vacant volume thereof, forming the chambers 420, 430, 440, 450, and the channel 410, wherein the chambers 430, 440 connect with the manifold 400, the chambers 420, 450 connect with the channel 410, chamber pairs 420 and 430, 440 and 450 are staggered, with chambers 420 and 440, 430 and 450 are paired symmetrically. The distance between the dead end of chambers 430, 440 and the opening center of the manifold is about 250˜290 μm.

Finally, the protective layer 370, the isolation layer 340, and the structural layer 320 are etched in order by plasma etching, chemical vapor etching, laser etching, or reactive ion etching (RIE) to form nozzles 385 connecting to the chambers 430 and 440.

If the injection density of a single row of chambers is 300 dpi, resolution can be increased to 600 dpi by staggering two rows of the chambers 430 and 440 in the embodiment.

### Second Embodiment

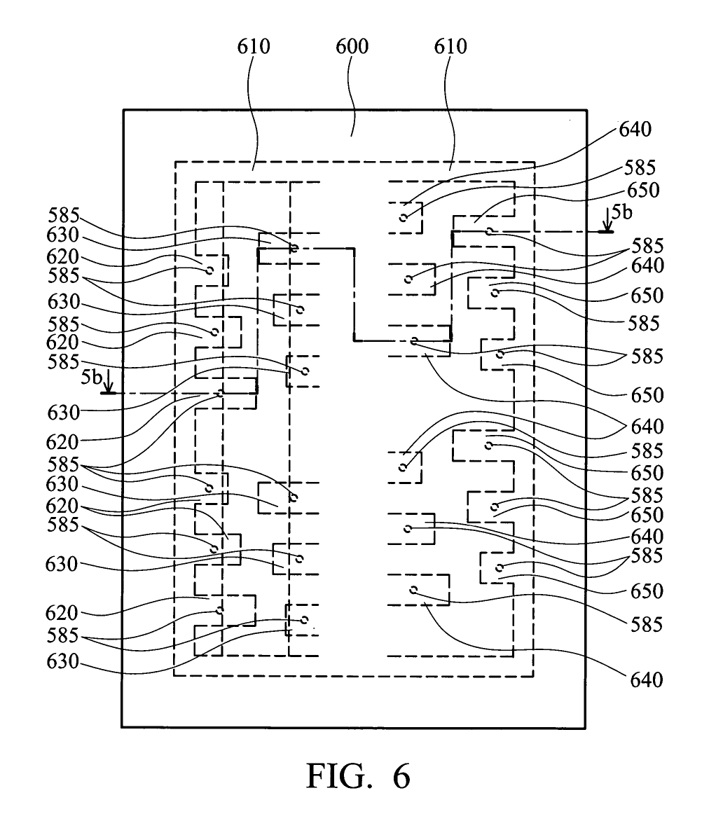

The fluid injection device in this embodiment features a connection system for chambers 620, 630, 640, 650, the channel 610, and the manifold 600, positioned as shown in FIG. 6. The distinction between this and the first embodiment is that the latter merely discloses two chambers 430 and 440 as staggered, but here, all chambers 620, 630, 640, 650 are staggered.

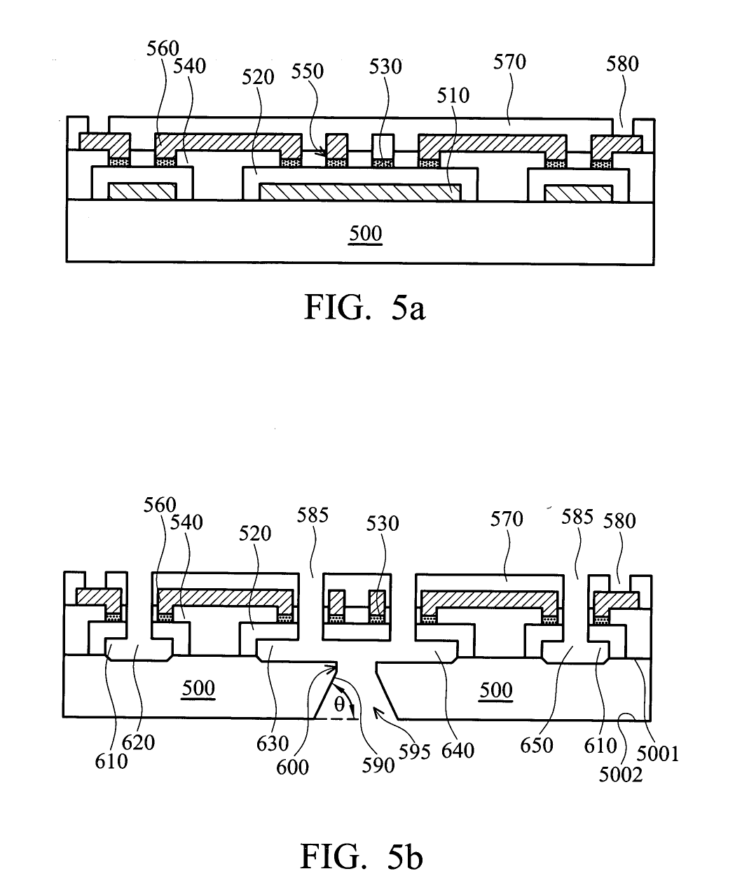

The above device structure is illustrated in FIG. 5b (a cross section) and FIG. 6 (a top view), wherein FIG. 5b is a cross section along the tangent line 5b-5b of FIG. 6. The fluid injection structure includes a substrate 500, a fluid channel 590, a manifold 600, four rows of chambers 620, 630, 640, 650, a channel 610, a structural layer 520, a resist layer 530, an isolation layer 540, a conductive layer 560, a protective layer 570, a plurality of signal transmission line contacts 580, and a plurality of nozzles 585.

The fluid channel 590 and the manifold 600 are formed in the substrate 500, wherein the manifold 600 is a narrow section of the fluid channel 590. Four rows of chambers 620, 630, 640, 650 and the channel 610 are formed between the substrate 500 and the structural layer 520, wherein chambers 630 and 640 are connected with the manifold 600, and chambers 620 and 650 are connected with the channel 610. The manifold 600 connects to the channel 610, owing to the circular channel 610 around the chambers 620, 630, 640, 650. Thus, connections between the chambers 620, 630, 640, 650, the channel 610, and the manifold 600 are formed, and all chambers 620, 630, 640, 650 are staggered.

Structural layer 520 covers the substrate 500 and chambers 620, 630, 640, 650. The resist layer 530 is installed on the structural layer 520, and both sides of nozzles. The resist layer 530 represents a plurality of fluid actuators, such as heaters, driving fluid out of nozzles 585. The isolation layer 540 covers the substrate 500, the structural layer 520 and the resist layer 330, exposing a portion of the resist layer 330 to form heater contacts. The conductive layer 560 covers the isolation layer 540 and fills heater contacts to form signal transmission lines.

The protective layer 570 covers the isolation layer 540 and the conductive layer 560, exposing a portion of the conductive layer 560 to form a plurality of signal transmission line contacts 580, thereby facilitating subsequent packaging process. A plurality of nozzles 585 are formed through the protective layer 570, the isolation layer 540, and the structural layer 520, and connected to the chambers 620, 630, 640, 650.

The device structure of this embodiment features the connection of chambers 620, 630, 640, 650, the channel 610, and the manifold 600. Compared to the related art, in which one row of chambers corresponds to one manifold, the embodiment provides all chambers 620, 630, 640, 650 corresponding to the single manifold 600, thereby reducing complexity of process. In addition, staggering all chambers 620, 630, 640, 650 significantly improves injection density.

Referring to FIGS. 5a, 5b, and 6, a method of fabricating the monolithic fluid injection device is provided. First, referring to FIG. 5a, a substrate 500 is provided, such as a silicon substrate. The thickness of the substrate 500 is about 625˜675 μm. Subsequently, a patterned sacrificial layer 510 is formed on a first plane 5001 of the substrate 500. The sacrificial layer 510 comprises BPSG, PSG, or silicon oxide, preferably PSG. The thickness of the sacrificial layer 510 is about 1˜2 μm.

Referring to FIG. 6, the above patterned sacrificial layer is formed in a predetermined region of a channel 610 and four rows of chambers 620, 630, 640, 650.

Next, a patterned structural layer 520 is formed on the substrate 500 to cover the patterned sacrificial layer 510. The structural layer 520 may be silicon nitride formed by CVD. The thickness of the structural layer 520 is about 1.5˜2 μm. Additionally, the structural layer 520 is a low-stress material with stress thereof about 100˜200 mPa.

Subsequently, a patterned resist layer 530 is formed on the structural layer 520, as fluid actuators, such as heaters, thereby driving fluid out of subsequently formed nozzles. The resist layer 530 comprises HfB₂, TaAl, TaN, or TiN, and is preferably TaAl.

A patterned isolation layer 540 is then formed to cover the substrate 500, the structural layer 520 and the resist layer 530, forming heater contacts 550. Subsequently, a patterned conductive layer 560 is formed on the isolation layer 540, and fills heater contacts 550 to form signal transmission lines. Finally, a protective layer 570 is formed on the isolation layer 540 and the conductive layer 560, exposing the conductive layer 560, thereby forming signal transmission line contacts 580 to facilitate subsequent packaging.

Subsequently, referring to FIG. 5b, a series of etching steps is performed. First, a second plane 5002 of the substrate 500 is anisotropic wet etched to form a fluid channel 590, a manifold 600, and an opening 595 using TMAH or KOH, exposing the sacrificial layer 510.

The width of the manifold 600 is about 160˜200 μm, and the width of the opening 595 is about 1000˜1200 μm. The included angle between the side walls of the fluid channel 590 and the horizontal factor is about 54.74°. Thus, after etching, a fluid channel 590 with a rear opening larger than its front opening is formed. Additionally, the fabrication process is a monolithic process because the fluid channel 590 is fabricated in the substrate 500. Furthermore, the fluid channel 590 connects to a fluid storage tank.

Next, the sacrificial layer 510 is removed by HF, and the substrate 500 is subsequently etched by a basic etching solution, such as KOH, to enlarge the vacant volume thereof, forming the chambers 620, 630, 640, 650, and the channel 610, wherein the chambers 630, 640 connect with the manifold 600, the chambers 620, 650 connect with the channel 610, and all chambers 620, 630, 640, 650 are staggered. The distance between the dead end of chambers 630, 640 and the opening center of the manifold is about 250˜290 μm.

Finally, the protective layer 570, the isolation layer 540, and the structural layer 520 are etched in order by plasma etching, chemical vapor etching, laser etching, or reactive ion etching (RIE) to form nozzles 585 connecting to the chambers 630 and 640.

If the injection density of a single row of chambers is 300 dpi, resolution can be increased to 1200 dpi by staggering all chambers 620, 630, 640, 650 in the embodiment. In addition, printing quality is improved, owing to increased resolution.

### Third Embodiment

The fluid injection device in this embodiment features a connection system for chambers 820, 830, 840, 850, the channel 810, and the manifold 800, staggering all chambers 820, 830, 840, 850, and variation in chamber sizes, for example, d9>d10>d11. The distinction between this embodiment and the previous embodiment is the latter merely disclosing staggering all chambers 620, 630, 640, 650, but here, at least two chamber sizes differ in addition to being staggered.

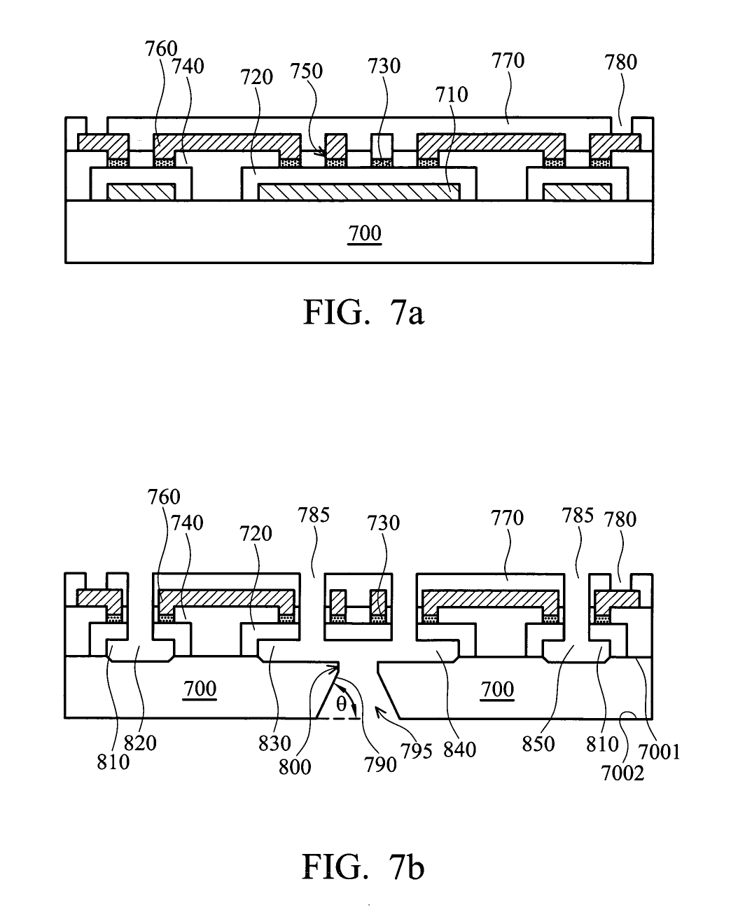

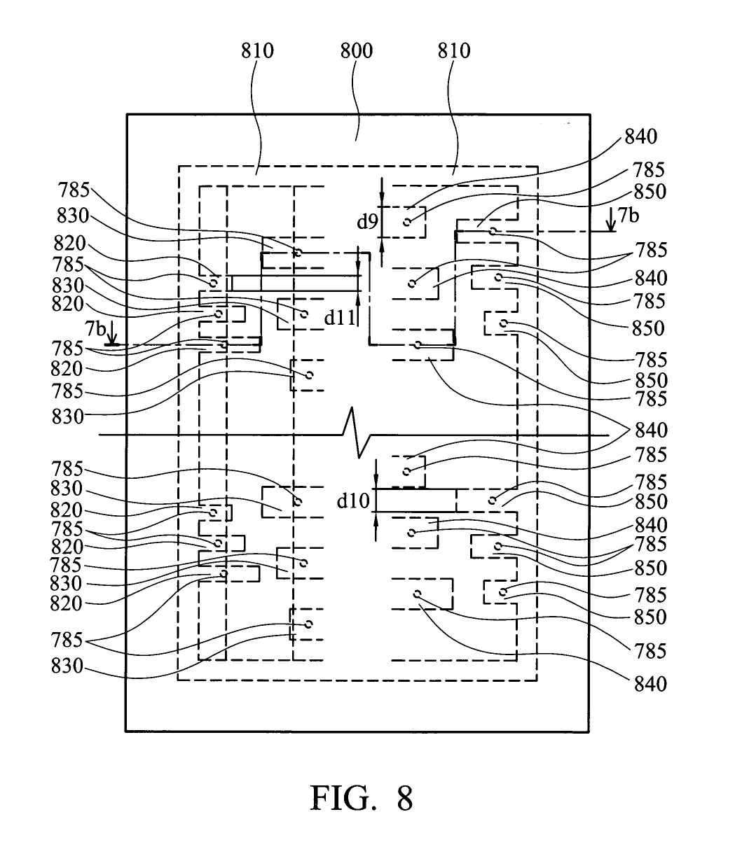

The above device structure is illustrated in FIG. 7b (a cross section) and FIG. 8 (a top view), wherein FIG. 7b is a cross section along the tangent line 7b-7b of FIG. 8. The fluid injection structure includes a substrate 700, a fluid channel 790, a manifold 800, four rows of chambers 820, 830, 840, 850, a channel 810, a structural layer 720, a resist layer 730, an isolation layer 740, a conductive layer 760, a protective layer 770, a plurality of signal transmission line contacts 780, and a plurality of nozzles 785.

The fluid channel 790 and the manifold 800 are formed in the substrate 700, wherein the manifold 800 is a narrow section of the fluid channel 790. Four rows of chambers 820, 830, 840, 850 and the channel 810 are formed between the substrate and the structural layer 720, wherein chambers 830 and 840 are connected with the manifold 800, and chambers 620 and 650 are connected with the channel 810. The manifold 800 connects to the channel 810, owing to the circular channel 810 around the chambers 820, 830, 840, 850. Thus, the connection of the chambers 820, 830, 840, 850, the channel 810, and the manifold 800 is formed, all chambers 820, 830, 840, 850 are staggered, and at least two chamber sizes are different, for example, d9>d10>d11.

The structural layer 720 covers the substrate 700 and chambers 820, 830, 840, 850. The resist layer 730 is installed on the structural layer 720, and both sides of nozzles. The resist layer 730 represents a plurality of fluid actuators, such as heaters, driving fluid out of nozzles 785. The isolation layer 740 covers the substrate 700, the structural layer 720, and the resist layer 730, exposing a portion of the resist layer 730 to form heater contacts. The conductive layer 760 covers the isolation layer 740 and fills heater contacts to form signal transmission lines.

The protective layer 770 covers the isolation layer 740 and the conductive layer 760, exposing a portion of the conductive layer 760 to form a plurality of signal transmission line contacts 780, thereby facilitating subsequent packaging. A plurality of nozzles 785 are formed through the protective layer 770, the isolation layer 740, and the structural layer 720, and connected to the chambers 820, 830, 840, 850.

The device structure of the embodiment features the connection of chambers 820, 830, 840, 850, the channel 810, and the manifold 800. Compared to the related art, in which one row of chambers corresponds to one manifold, the invention provides all chambers 820, 830, 840, 850 corresponding to the single manifold 800, thereby reducing complexity of process. In addition, staggering all the chambers 820, 830, 840, 850 significantly improves injection density.

Referring to FIGS. 7a, 7b, and 8, a method of fabricating the monolithic fluid injection device is provided. First, referring to FIG. 7a, a substrate 700 is provided, such as a silicon substrate. The thickness of the substrate 700 is about 625˜675 μm. Subsequently, a patterned sacrificial layer 710 is formed on a first plane 7001 of the substrate 700. The sacrificial layer 710 comprises BPSG, PSG, or silicon oxide, preferably PSG. The thickness of the sacrificial layer 710 is about 1˜2 μm.

Referring to FIG. 8, the above patterned sacrificial layer is formed in a predetermined region of a channel 810 and four rows of chambers 820, 830, 840, 850.

Next, a patterned structural layer 720 is formed on the substrate 700 to cover the patterned sacrificial layer 710. The structural layer 720 may be silicon nitride formed by CVD. The thickness of the structural layer 720 is about 1.5˜2 μm. Additionally, the structural layer 720 is a low-stress material with stress thereof about 100˜200 mPa.

Subsequently, a patterned resist layer 730 is formed on the structural layer 720, as fluid actuators, such as heaters, thereby driving fluid out of subsequently formed nozzles. The resist layer 730 comprises HfB₂, TaAl, TaN, or TiN, and is preferably TaAl.

A patterned isolation layer 740 is then formed to cover the substrate 700, the structural layer 720 and the resist layer 730, forming heater contacts 750. Subsequently, a patterned conductive layer 760 is formed on the isolation layer 740, and fills heater contacts 750 to form signal transmission lines. Finally, a protective layer 770 is formed on the isolation layer 740 and the conductive layer 760, exposing the conductive layer 760, thereby forming signal transmission line contacts 780 to facilitate the subsequent packaging process.

Subsequently, referring to FIG. 7b, a series of etching steps are performed. First, a second plane 7002 of the substrate 700 is anisotropic wet etched to form a fluid channel 790, a manifold 800, and an opening 795 using TMAH or KOH, exposing the sacrificial layer 710.

The width of the manifold 800 is about 160˜200 μm, and the width of the opening 795 is about 1000˜1200 μm. The included angle between the side walls of the fluid channel 790 and the horizontal factor is about 54.74°. Thus, after etching, a fluid channel 790 with a back opening larger than its front opening is formed. Additionally, the fabrication process is a monolithic process because the fluid channel 790 is fabricated in the substrate 700. Furthermore, the fluid channel 790 connects to a fluid storage tank.

Next, the sacrificial layer 310 is removed by HF, and the substrate 700 is subsequently etched by a basic etching solution, such as KOH, to enlarge the vacant volume thereof, forming the chambers 820, 830, 840, 850, and the channel 710, wherein the chambers 830, 840 connect with the manifold 800, the chambers 820, 850 connect with the channel 810, and all chambers 820, 830, 840, 850 are staggered. The length between the dead end of chambers 830, 840 and the opening center of the manifold is about 250˜290 μm.

Finally, the protective layer 770, the isolation layer 740, and the structural layer 720 are etched in order by plasma etching, chemical vapor etching, laser etching, or reactive ion etching (RIE) to form nozzles 785 connecting the chambers 830 and 840.

If the injection density of a single row of chambers is 300 dpi, resolution can be increased to 1200 dpi by staggering all chambers 820, 830, 840, 850 in the embodiment. In addition, printing quality is improved, owing to increased resolution. Further, the present invention provides multi-level printing effect due to the variation in chamber sizes.

In conclusion, the number of chambers is increased while keeping a single manifold by means of the specific photomask having the connection of a manifold, a channel, and chambers, thereby reducing complexity and process cost, and freeing more bottom area of the wafer.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A monolithic fluid injection device, comprising:
a substrate;
a structural layer formed on the substrate;
a manifold installed in the substrate to supply fluid;
a plurality of first chambers installed between the substrate and the structural layer to contain injected fluid, wherein the first chambers connect directly to the manifold;
at least a second chamber installed between the substrate and the structural layer to contain injected fluid, wherein the second chamber indirectly connects to the manifold;
a channel installed between the substrate and the structural layer to supply fluid to the second chamber; and
a plurality of nozzles through the structural layer, connecting to the first and second chambers to inject fluid.

2. The monolithic fluid injection device as claimed in claim 1, wherein the channel is installed around the first and second chambers.

3. A method of fabricating a monolithic fluid injection device, comprising:
providing a substrate;
forming a patterned sacrificial layer on the substrate, wherein the patterned sacrificial layer is a predetermined region of a channel and a plurality of chambers;
forming a patterned structural layer on the substrate to cover the patterned sacrificial layer;
forming a manifold through the substrate to expose the patterned sacrificial layer;
removing the sacrificial layer to form the channel and the chambers, wherein the chambers comprise a plurality of first chambers and at least a second chamber, the first chambers directly connect to the manifold, and the second chamber connects to the manifold by the channel; and
etching the structural layer to form a plurality of nozzles connected to the chambers.

4. The method as claimed in claim 3, wherein the sacrificial layer comprises BPSG, PSG, or silicon oxide.

5. The method as claimed in claim 3, wherein the thickness of the sacrificial layer is about 1˜2 μm.

6. The method as claimed in claim 3, wherein the structural layer comprises silicon nitride.

7. The method as claimed in claim 3, wherein the thickness of the structural layer is about 1.5˜2 μm.

8. The method as claimed in claim 3, wherein the structural layer is a low-stress material.

9. The method as claimed in claim 8, wherein the stress is about 100˜200 MPa.

10. The method as claimed in claim 3, wherein at least two rows of chambers are paired staggering.

11. The method as claimed in claim 3, wherein all chambers are staggered.

12. The method as claimed in claim 3, wherein all chambers are staggered, and have various sizes.

13. The method as claimed in claim 3, wherein the channel is installed around the chambers.

14. The method as claimed in claim 3, after the sacrificial layer is removed, further comprising, increasing chamber volumes.
